(19) United States
(12) Patent Application Publication
(10) Pub. No.: US 2015/0142410 A1
(43) Pub. Date: May 21, 2015

(54) HETEROJUNCTION BIPOLAR TRANSISTOR RELIABILITY SIMULATION METHOD

(71) Applicants: STMicroelectronics SA, Montrouge (FR); STMicroelectronics (Crolles 2) SAS, Crolles (FR)

(72) Inventors: Salim Ighilahriz, Grenoble (FR); Florian Cacho, Grenoble (FR); Vincent Huard, Le Versoud (FR)

(21) Appl. No.: 14/541,627

(22) Filed: Nov. 14, 2014

(30) Foreign Application Priority Data
Nov. 15, 2013 (FR) 1361179

(51) Int. Cl. G06F 17/50

(52) U.S. Cl. CPC G06F 17/5036
USPC 703/14

(57) ABSTRACT

A method of circuit simulation includes: simulating, by a processing device, behavior of a heterojunction bipolar transistor device based on at least a first base-emitter voltage of the transistor to determine a first base or collector current density of the HBT device; and determining whether the application of the first base-emitter voltage to the HBT device will result in base current degradation by performing a first comparison of the first current density with a first current density limit.

### CROSS-REFERENCE(S) TO RELATED APPLICATION(S)

This application claims the priority benefit of French Patent Application number 13/61179, filed on Nov. 15, 2013, the contents of which is hereby incorporated by reference in its entirety to the maximum extent allowable by law.

### BACKGROUND

1. Technical Field

The present application relates to a method and apparatus for simulating the operation of a heterojunction bipolar transistor (HBT) device, and in particular to a method for evaluating the reliability of an HBT device based on degradation of the device.

2. Description of the Related Art

Heterojunction bipolar transistors (HBTs) are widely used in high speed applications due to their good performance at millimeter wavelengths, for example in the frequency range 30 to 300 GHz.

The operating limits of HBTs are generally characterized by a collector-emitter breakdown voltage, which defines a collector-emitter voltage limit above which there is a high risk of transistor breakdown, or at least a relatively high degradation in the transistor's performance.

A problem is that, in general, high frequency applications of HBT devices involve aggressive biasing conditions, which can easily cause such a collector-emitter breakdown voltage to be exceeded. Therefore, current simulation methods tend to lead to a high failure rate of HBT devices when simulated for high frequency applications.

### BRIEF SUMMARY

One embodiment of the present disclosure at least partially addresses one or more problems in the prior art.

According to one aspect, there is provided a method of circuit simulation comprising: simulating, by a processing device, behavior of a heterojunction bipolar transistor device based on at least a first base-emitter voltage of said transistor to determine a first base or collector current density of said HBT device; and determining whether the application of said first base-emitter voltage to said HBT device will result in base current degradation by performing a first comparison of said first current density with a first current density limit.

According to one embodiment, the first current density limit corresponds to an operating limit of the HBT device, and determining whether the first base-emitter voltage will result in base current degradation comprises determining whether the operating limit is exceeded.

According to one embodiment, the first base or collector current density is determined based on a first collector-emitter voltage of the transistor, the method further comprising: simulating said HBT device based on said first base-emitter voltage of the transistor and a second collector-emitter voltage to determine a second base or collector current density of the HBT device; performing a second comparison of the second current density with a second current density limit; and determining a first collector-emitter voltage limit for the first base-emitter voltage based on the first and second comparisons.

According to one embodiment, the method further comprises: determining, by the processing device for a second base-emitter voltage of the transistor, a second collector-emitter voltage limit; determining, by simulation, a first collector-emitter voltage of the transistor for the first base-emitter voltage; determining, by simulation, a second collector-emitter voltage of the transistor for the second base-emitter voltage; and generating by the processing device an alert signal if the first collector-emitter voltage exceeds the first collector-emitter voltage limit or if the second collector-emitter voltage exceeds the second collector-emitter voltage limit.

According to one embodiment, the method further comprises: determining, by simulation, a first collector-emitter voltage of the transistor for the first base-emitter voltage; and determining an estimation of the base current degradation of the HBT device after a time duration during which the first collector-emitter voltage is applied to the HBT device based on a comparison between the first collector-emitter voltage and the first collector-emitter voltage limit.

According to one embodiment, the estimation of the base current degradation of the HBT device after a time duration is determined based on at least one of the equations:

deg radation=At^{P1}

where t is the time duration and A and P1 are constants; and

$$degradation = \frac{B}{\frac{1}{{t}^{P 2}} + C}$$

where t is the time duration and B, C and P2 are constants.

According to one embodiment, the base-emitter voltage V_{BE} of the HBT device has a periodic waveform, each period of the waveform being defined by a plurality of base-emitter voltage values (V_{BEi}), the method further comprising: determining a plurality of collector-emitter voltage limits, each limit corresponding to a respective one of the plurality of base-emitter voltage values; determining by simulation a plurality of collector-emitter voltages each corresponding to a respective one of the plurality of base-emitter voltage values; and generating by the processing device an alert signal if any one of the plurality of collector-emitter voltages exceeds a corresponding one of the plurality of collector-emitter voltage limits.

According to one embodiment, the method further comprises comparing the first base-emitter voltage with a voltage threshold, wherein: if the first base-emitter voltage is lower than the voltage threshold, the first base or collector current density is a first base current density; and if the first base-emitter voltage is higher than the voltage threshold, the first base or collector current density is a first collector current density.

According to one embodiment, the first current density is a first base current density, the method further comprising, before performing the first comparison, determining the first base current density limit by determining an initial base current density for the first base-emitter voltage, the first base current density limit being equal to the initial base current density minus a maximum base current drop.

According to one embodiment, the initial base current density is determined for a collector-emitter voltage in the range 0.2 to 1.5 V.

According to one embodiment, the first current density is a first collector current density, the method further comprising, before performing the first comparison, determining the first collector current density limit based on the first base-emitter voltage and a corresponding temperature value of the HBT device.

According to one embodiment, the first current density limit is determined by the following formula:

J_{CLi}=min[γe^{αT}^{ₑ}^{(βT+ζ)V}^{_{BE}},J_{Cmax}]

where γ, α, β and ζ are constants, T is the temperature of the HBT device, V_{BE} is the base-emitter voltage and J_{Cmax} is a maximum current limit independent of temperature or of the base-emitter voltage.

According to a further aspect, there is provided a method of circuit conception comprising: the conception of a circuit comprising at least one HBT device; simulating the behavior of the at least one HBT device by the above method.

According to a further aspect, there is provided a non-transitory data storage device storing instructions that, when executed by a processing device, cause the above method to be implemented.

According to a further aspect, there is provided a device for circuit simulation comprising: a processing device configured to: simulate the behavior of a heterojunction bipolar transistor device based on at least a first base-emitter voltage of the transistor to determine a first base or collector current density of the HBT device; and determine whether the application of the first base-emitter voltage to the HBT device will result in base current degradation by performing a first comparison of the first current density with a first current density limit.

### BRIEF DESCRIPTION OF THE SEVERAL VIEWS OF THE DRAWINGS

The foregoing and other features and advantages will become apparent from the following detailed description of embodiments, given by way of illustration and not limitation with reference to the accompanying drawings, in which:

FIG. 1A schematically illustrates an HBT device;

FIG. 1B is a graph illustrating collector-emitter voltage limits of an HBT device according to an example embodiment;

FIG. 2A is a flow diagram illustrating steps in a method of simulating an HBT device according to an example embodiment of the present disclosure;

FIG. 2B schematically illustrates simulation apparatus for the simulation of an HBT device according to an example embodiment of the present disclosure;

FIG. 3 is a flow diagram illustrating steps in a method of determining collector-emitter voltage limits in an HBT device according to an example embodiment of the present disclosure;

FIG. 4A is a graph showing an example of the collector current measurements of an HBT device for a range of collector-emitter voltages V_{CE} and a constant base-emitter voltage V_{BE};

FIG. 4B is a graph showing an example collector current density limits for a range of base-emitter voltages V_{BE} and temperatures;

FIG. 5 is a flow diagram illustrating steps in a method of determining collector-emitter voltage limits in an HBT device according to a further example embodiment of the present disclosure;

FIG. 6 is a graph showing an example of the base current of an HBT device for a range of collector-emitter voltages V_{CE} and a constant base-emitter voltage;

FIG. 7 is a flow diagram illustrating steps in a method of estimating HBT degradation over time;

FIG. 8 is a graph illustrating an example of base current degradation with time in an HBT device based on avalanche degradation; and

FIG. 9 is a graph illustrating an example of base current degradation with time in an HBT device based on self heating degradation.

### DETAILED DESCRIPTION

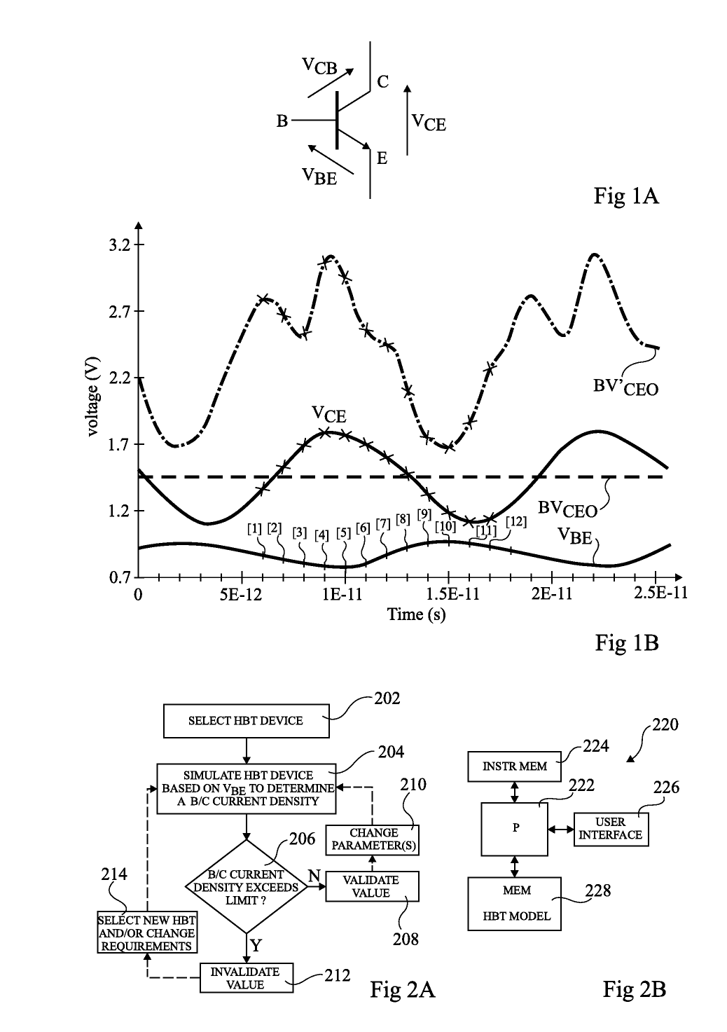

FIG. 1A schematically illustrates an HBT device comprising a base node, a collector node and an emitter node. As illustrated, three voltages characterize the behavior of the transistor: the base-emitter voltage V_{BE} between the base and emitter; the collector base voltage V_{CB} between the collector and base; and the collector-emitter voltage V_{CE} between the collector and emitter.

Throughout the following description, it will be assumed that an HBT device to be simulated is in a forward mode of operation in which both the base-emitter voltage V_{BE} and the collector-base voltage V_{CB} of the device are positive.

FIG. 1B is a graph illustrating an example of a base-emitter voltage signal V_{BE} for a specific application of the device. This voltage signal for example has a periodic waveform, the period of the signal in FIG. 1B being in the region of 1.3×10⁻¹¹ corresponding to a frequency in the region of 77 GHz. In the example of FIG. 1B, the V_{BE} signal for example varies between a lower voltage of 0.75 V and a higher voltage of 1 V.

FIG. 1B equally illustrates an example of a collector-emitter voltage signal V_{CE} resulting from the application of the base-emitter voltage signal V_{BE} to an HBT device. This signal is for example generated by simulation. As illustrated, the V_{CE} signal also has a periodic waveform with the same period as the V_{BE} signal. In the example of FIG. 1B, the V_{CE} signal varies between a lower voltage of 1.1 and a higher voltage of 1.8 V.

As represented by a dashed line in FIG. 1B, according to simulation methods that have previously been proposed, the HBT device could be characterized as having a collector-emitter breakdown voltage limit BV_{CEO} at a constant value of 1.45 V. Therefore, each time that the collector-emitter voltage V_{CE} signal exceeds this voltage threshold, the transistor's operating limits are deemed to be exceeded, and the circuit designer is obliged to either modify the operating parameters, or select a different type of HBT device.

As represented by a dashed-dotted line in FIG. 1B, according to embodiments described herein, a signal BV′_{CEO} for example defines a time-varying collector-emitter breakdown voltage signal. The signal BV′_{CEO} is for example calculated as a function of the V_{BE} signal, and thus also has a periodic waveform with the same period as the V_{BE} signal. The V_{BE} signal is for example defined by a plurality of values over a period, and for each value, a corresponding voltage limit of the signal BV′_{CEO} is calculated. For example, as shown in FIG. 1B, a period of the signal V_{BE} is defined by 12 values [1] to [12] at intervals of 1×10⁻¹¹ s, and for each of these values, a corresponding voltage limit of the signal BV′_{CEO} is defined, shown by a cross in FIG. 1B. Of course, in alternative embodiments, different numbers of V_{BE} values defining a period of the V_{BE} signal would be possible, with intervals of different durations there between.

Techniques for determining the signal BV′_{CEO} will be described in more detail below, and for example lead to a significant increase in the V_{CE} voltage limit for some or all of the V_{BE} voltage values. Indeed, in the example of FIG. 1B, the signal BV′_{CEO} varies between 1.65 and 3.1 V. Furthermore, even though the lowest point of 1.65 V of the signal BV′_{CEO} is lower than the highest point of 1.8 V of the signal V_{CE}, these points do not coincide in time, and thus no point of the V_{CE} signal exceeds the limit defined by the signal BV′_{CEO}.

For example, a method of simulating an HBT device involves generating by simulation, for at least two points of the V_{BE} signal, corresponding points of the V_{CE} signal and corresponding points of the breakdown voltage signal BV′_{CEO}. A comparison is then performed between each generated point of the V_{CE} signal with the corresponding voltage limit of the BV′_{CEO} signal, and if the limit is exceeded, an alert signal is for example generated to inform the designer that the operating limits of the HBT device have been exceeded.

FIG. 2A is a flow diagram showing steps in a method of simulating an HBT device according to an example embodiment. The method is for example implemented by a simulation device described in more detail below.

In a first step 202, an HBT device is for example selected. For example, various behavioral models associated with a plurality of different HBT devices may be stored by a memory of the simulation device, each HBT device for example being characterized by one or more parameters such as its dimensions. By a selection of one of the HBT devices, a corresponding behavioral model is for example selected.

In a subsequent step 204, the operation of the HBT device is simulated using the model of the HBT device based on a base-emitter voltage V_{BE}, in order to determine a base or collector current density of the selected HBT device. For example, the base-emitter voltage is one of the values [1] to [12] of the signal V_{BE} of FIG. 1B. The simulation of the HBT operation for example involves determining the collector-emitter voltage V_{CE} resulting from the base-emitter voltage.

As will be described in more detail below, the V_{CE} voltage limits are for example defined based on one of two effects that cause degradation in the HBT device. One of these effects is self-heating degradation characterized by an excessive collector current density. The other effect is avalanche degradation characterized by a relatively high drop in the base current density.

In a subsequent step 206, the base or collector current density determined in step 204 is compared to a current density limit. This determination indicates whether or not the application of said first base-emitter voltage to the HBT device will cause base current degradation, and for example corresponds to an operating limit of the HBT device. Thus, if this limit is not exceeded, the next step is 208, in which the base-emitter voltage can be validated, in other words it is deemed not to cause degradation in the HBT device. In some embodiments, the method then returns to step 204 after the modification of one or more parameters of the HBT device in step 210, for example to verify other base-emitter voltages, or in order to determine a collector-emitter voltage limit for the given base-emitter voltage V_{BE}.

If in step 206 the current density limit is exceeded, the next step is 212, in which the simulated base-emitter voltage V_{BE} and/or the collector-emitter voltage V_{CE}, are invalidated, in other words it is deemed that these values exceed the operating limits of the HBT device above which degradation will occur. Optionally, the method proceeds with a further step 214 in which a new HBT device is selected and/or the device requirements are adapted, and the method then returns to step 204.

FIG. 2B illustrates a simulation apparatus 220 configured to implement the simulation method of FIG. 2A, and/or the methods described hereafter. The apparatus 220 comprises for example a processing device 222 having one or more processors under the control of an instruction memory 224. The instructions stored by the instruction memory 224 cause the simulation methods described herein to be performed. The hardware also for example comprises a user interface 226 coupled to the processing device 222, and for example comprising a display and/or input device such as a keyboard or mouse. A memory 228 is also for example coupled to the processing device 222, and stores one or more HBT device models for use in simulating the operation of the HBT devices.

As mentioned above, according to the embodiments described herein, the operating limits of the HBT device are for example determined based on two principle HBT effects, one known as avalanche degradation, and the other as self-heating degradation.

Avalanche degradation is a phenomenon that occurs when the base-emitter voltage is relatively low and the collector-emitter voltage exceeds a certain limit. As the collector-emitter voltage rises, the base current falls, until a point at which breakdown of the collector-base junction occurs.

Self-heating degradation is a phenomenon that occurs when the base-emitter voltage is relatively high, and the collector-emitter voltage exceeds a certain limit. As the collector-emitter voltage rises, the current in the collector increases, inducing self-heating of device until a breakdown point at which fusion of the collector base junction occurs.

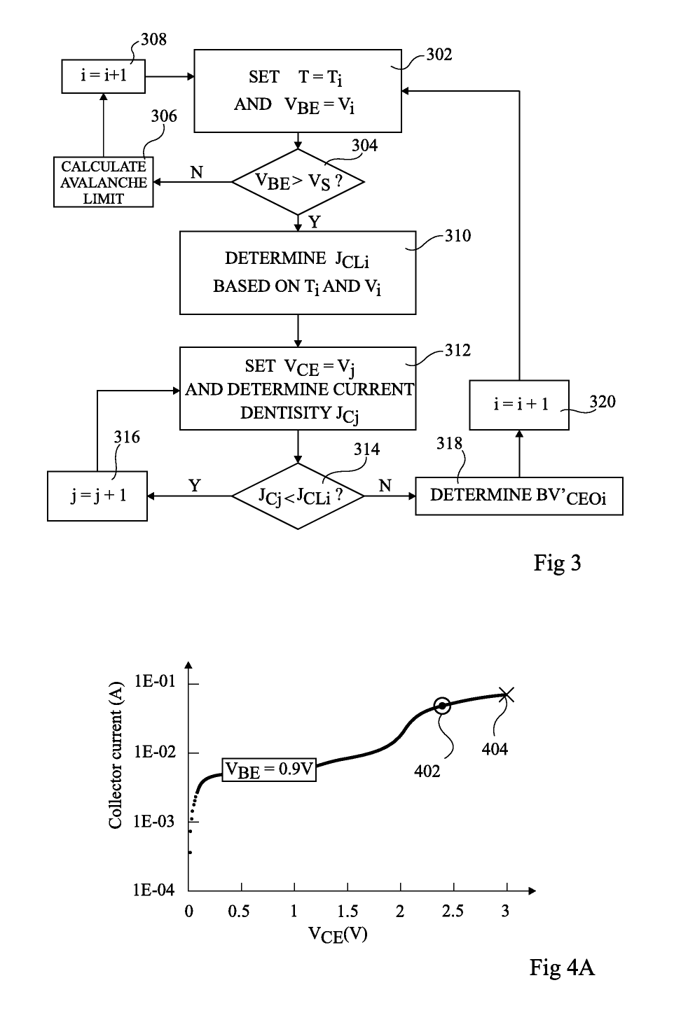

In some embodiments, the method of FIG. 2A can be used to directly determine whether, for an HBT device, a certain base emitter voltage V_{BE} and collector emitter voltage V_{CE} will lead to device breakdown based on either avalanche or self-heating degradation. Alternatively, the method of FIG. 2A may be used to determine one or more collector emitter voltage limits for an HBT device, as will now be described in more detail with reference to FIGS. 3 to 6.

FIG. 3 is a flow diagram illustrating steps in a method of determining collector-emitter voltage limits based on self-heating degradation.

In a first step 302, a temperature parameter T of the device is for example set to a temperature value Tᵢ, and a base-emitter voltage V_{BE} of the device is set to a voltage Vᵢ. The variable i is for example initially set to 1, and thus initially the temperature is set to a first temperature value T₁, and the voltage V_{BE} to a first voltage value V₁. There are for example I V_{BE} voltage values V₁ to V_{I}, which for example corresponds respectively to the level [1] to [12] of FIG. 1B. The temperature value Tᵢ is for example the temperature of the HBT device environment.

In a subsequent step 304, it is determined whether the base-emitter voltage V_{BE} exceeds a threshold level V_{S}. In particular, as explained above, depending on the level of the base-emitter voltage V_{BE}, the device can be characterized as being limited by either avalanche or self-heating degradation. In one example, this voltage threshold V_{S} is in the range of 0.75 and 1 V, and is for example at 0.9 V. Step 304 can be omitted for example in the case that only the self-heating phenomenon is to be used to determine the collector-emitter voltage limit V_{CE}, if for example it is known in advance that the emitter-base voltage will not fall below the threshold voltage V_{S}.

If V_{BE} does not exceed the threshold voltage V_{S}, in a subsequent step 306, a voltage limit based on avalanche degradation is for example calculated in a step 306, as will be described in more detail below with reference to FIG. 5. The variable i is then for example incremented in a step 308, and the method returns to step 302.

If in step 304 it is determined that the base-emitter voltage V_{BE} exceeds the voltage threshold V_{S}, the next step is 310, in which a collector current density limit J_{Cli} is determined based on the temperature T and the voltage V_{BE}. For example, this is achieved based on the following formula:

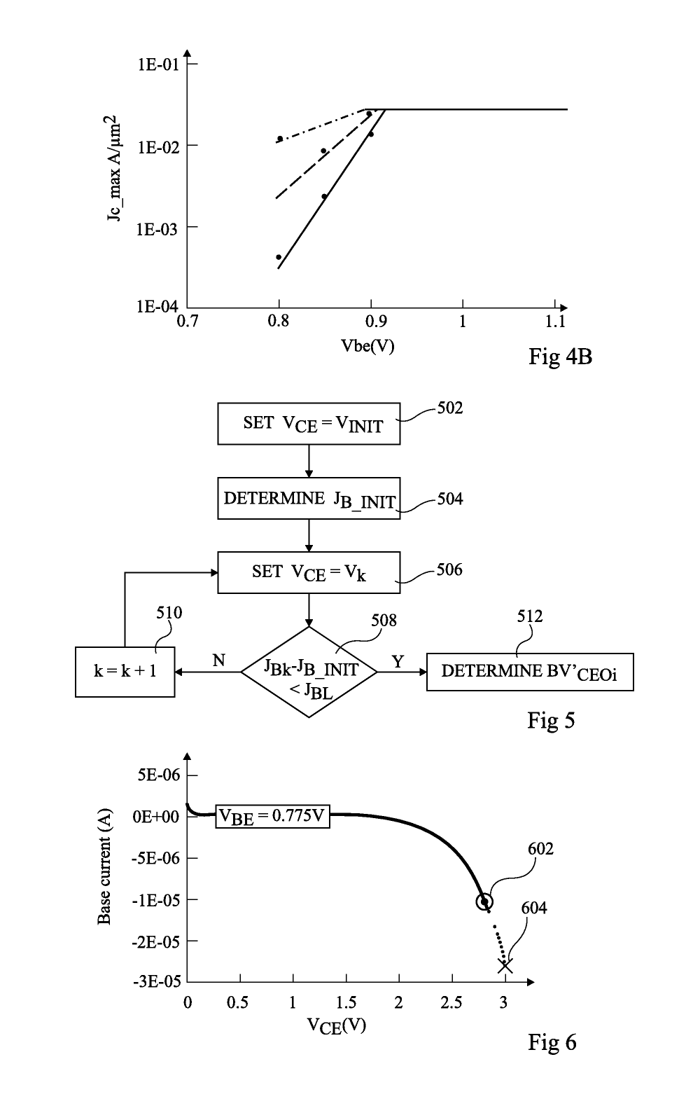

J_{CLi}=min[γe^{αT}^{ₑ}^{(βT+ζ)V}^{_{BE}},J_{Cmax}]

where γ, α, β and ζ are constants, T is the device temperature, for example in Kelvin, and J_{Cmax} is a current density limit that applies irrespectively of the base-emitter voltage and temperature of the device. For example, the current density limit may be between 4×10⁻⁴ and 1×10⁻¹ A/μm² and is for example approximately 2×10⁻² A/μm². This limit may be determined based on characteristics such as the dimensions of the device. In one specific example extracted from the measurements of FIG. 4A described in more detail below, γ is equal 2×10⁻⁸, α is equal to 0.2681, β is equal to 0.2896 and ζ is equal to 45.5. More generally, it will be apparent to those skilled in the art how these constants can be determined for a particular HBT device by appropriate measurements of the collector current at a given temperature T, base-emitter voltage V_{BE} and for one or more collector-emitter voltage levels V_{CE}.

In subsequent step 312, the value of the collector-emitter voltage V_{CE} is for example set to Vⱼ, where j is a variable that is for example initially set to 1. The value V₁ of the voltage V_{CE} is for example selected to be relatively low such that the operating limits of the HBT will not be exceeded. The collector current density J_{Cj} resulting from the application of the voltage level Vⱼ is then determined by simulation, for example using a behavioral model of the HBT device.

In a subsequent step 314, the collector current density J_{Cj} is compared to the current density limit J_{CLi} determined in step 310. If this level is not exceeded, the variable j is incremented in a subsequent step 316, and the method returns to step 312. Each voltage Vⱼ₊₁ is for example greater than the previous voltage Vⱼ by a constant step for example equal to 0.1 V, and this iterative process for example continues, until the current density limit J_{CLi} is exceeded. Thus an iterative process is used to determine the voltage level causing the operating limits to be exceeded.

When in step 314 the collector current density limit J_{CLi} is exceeded, the subsequent step is 318, in which the corresponding collector-emitter voltage limit BV′_{CEOi} is defined. For example, this voltage limit is defined as the previous collector-emitter voltage Vⱼ₋₁, this being the highest voltage for which the current density limit was not exceeded. In a subsequent step 320, i is for example incremented and the method returns to step 302 such that a collector-emitter voltage limit can be determined for another base-emitter voltage level V_{BE}. When all of the I voltage levels, for example each of the voltage levels [1] to [12] in FIG. 1B, have been evaluated, the method ends.

FIG. 4A is a graph illustrating, for an HBT device under test to which a base-emitter voltage of 0.9 V is applied and having a temperature of 27° C., an example of the variation of collector current measured as the collector-emitter voltage rises. The temperature for example corresponds to the temperature of the bench where the measurements are taken. As illustrated by a circle 402 in FIG. 4A, above a certain critical V_{CE} voltage, in this example equal to around 2.4 V, the collector current reaches a level above which degradation becomes significant with time. In other words, for each second that this stress is maintained, the degradation of the HBT device increases, thereby reducing its lifetime. While FIG. 4A corresponds to the case of a specific HBT device in which this collector current is equal to approximately 50 mA, by defining this current in terms of a current density, the present inventors have found that this limit can be applied to a wide range of HBT devices having different dimensions.

Furthermore, as shown by a cross 404, when the V_{CE} voltage reaches a breakdown voltage, in this example of around 3 V, the collector current reaches a level at which a breakdown of the HBT device occurs. In the example of FIG. 4A, this collector current is approximately 70 mA. However, again by defining this current in terms of a current density, the present inventors have found that this limit can be applied to a wide range of HBT devices.

The collector current density limit J_{CLi} determined in step 310 of FIG. 3 for example corresponds to the degradation limit 402 of the HBT device. For example, the constants γ, α, β and ζ of equation 1 above are determined based this measurement.

As will be described in more detail below, the present inventors have found that the critical voltage level can be used to estimate the degradation of the HBT device with time for a given temperature and for a given base-emitter voltage.

FIG. 4B illustrates examples of collector current density limits for an HBT device for a range of base-emitter voltages and for temperatures of 27° C. (solid line curve in FIG. 4B), 75° C. (dashed line curve in FIG. 4B) and 125° C. (dashed-dotted line curve in FIG. 4B). In this example, below a base-emitter voltage of around 0.9 V, the collector current density limit is a function of base-emitter voltage and temperature, whereas above this voltage, the current density limit J_{Cmax} is reached, above which degradation occurs irrespective of the base-emitter voltage and temperature.

FIG. 5 is a flow diagram illustrating steps in a method of determining a collector-emitter voltage limit based on avalanche degradation. Such a method is for example applied in step 306 of FIG. 3, or alternatively it may be applied independently of the method of FIG. 3, if for example it is known in advance that the emitter-base voltage will never go above the threshold voltage V_{S}.

In a first step 502, the voltage V_{CE} is for example set to a value V_{INIT}, which is for example an initial value at which it is known that the transistor is far from the avalanche limit. For example, this could be at a relatively low collector-emitter voltage V_{CE} of around 1 V, or more generally a collector-emitter voltage in the range 0.2 to 1.5 V. The base emitter voltage V_{BE} is assumed to be equal to Vᵢ in accordance with step 302 of FIG. 3.

In a subsequent step 504, an initial base current density J_{BINIT} for the HBT device is determined based on the voltages V_{BE} and V_{CE}. For example, this step can be performed using on a model of the HBT device.

In a subsequent step 506, the collector-emitter voltage V_{CE} is now set to a first value Vₖ. Initially, k is for example set to 1, and the value V₁ of the voltage V_{CE} is for example selected to be relatively low such that the operating limits of the HBT will not be exceeded. In one example, the voltages Vₖ is the same as the voltages Vⱼ of step 312 of FIG. 3.

In a subsequent step 508, a base current density J_{Bk} is calculated using the device model and based on the voltage V_{CE}, and also based on the base-emitter voltage V_{BE}. The initial base current J_{Binit} calculated in step 504 is then subtracted from the base current J_{Bk}, and the result is compared to a base current density limit J_{BL}. This step is equivalent to comparing the base current density J_{Bk} with a base current density limit calculated as J_{Binit}−J_{BL}. The limit J_{BL} defines a maximum fall in the base current density, and is for example a value in the range −8×10⁻⁵ to −1×10⁻⁶. The limit J_{BL} is for example determined by measurement for an HBT device. For a given HBT device, the base current density limit is a function of the base-emitter voltage V_{BE} applied to device.

If the limit is not exceeded, the next step is 510, in which k is incremented, and then the method returns to step 506. Each voltage Vₖ₊₁ is for example greater than the previous voltage Vₖ by a constant step for example equal to 0.1 V, and this iterative process for example continues, until the current density limit is exceeded. The method then goes to step 512, in which the corresponding collector-emitter voltage limit BV′_{CEOi} is determined. For example, this voltage limit is defined as the previous collector-emitter voltage Vₖ₋₁, this being the highest voltage for which the current density limit was not exceeded.

The method for example then returns to step 308 of FIG. 3, or alternatively, in the case that the method of FIG. 5 is applied independently of the self-heating degeneration limit, the method may be repeated for a new value Vᵢ of the base-emitter voltage V_{BE}.

FIG. 6 is a graph illustrating, for a given base-emitter voltage of 0.775 V, an example of the variation of base current as the collector-emitter voltage rises. As illustrated by a circle 602 in FIG. 6, above a certain critical V_{CE} voltage, in this example equal to around 2.8 V, the base current falls by an amount that indicates that degradation has become significant over time. In other words, for each second that this stress is maintained, the degradation of the HBT device increases, thereby reducing its lifespan. While FIG. 6 corresponds to the case of a specific HBT device in which this base current drop is equal to approximately 10 μA, by defining this current in terms of a current density, the present inventors have found that this limit can be applied to a wide range of HBT devices.

Furthermore, as shown by a cross 604, when the V_{CE} voltage reaches a breakdown voltage, in this example of around 3 V, the base current has fallen by a level at which a breakdown of the HBT device occurs. In the example of FIG. 6, this base current drop is equal to approximately 26 μA. However, again by defining this current in terms of a current density, the present inventors have found that this limit can be applied to a wide range of HBT devices.

The base current density limit J_{BL} of step 508 of FIG. 5 for example corresponds to the degradation limit 602 of the HBT device. As will be described in more detail below, the present inventors have found that the critical voltage level can be used to estimate the lifespan of the HBT device for a given base-emitter voltage.

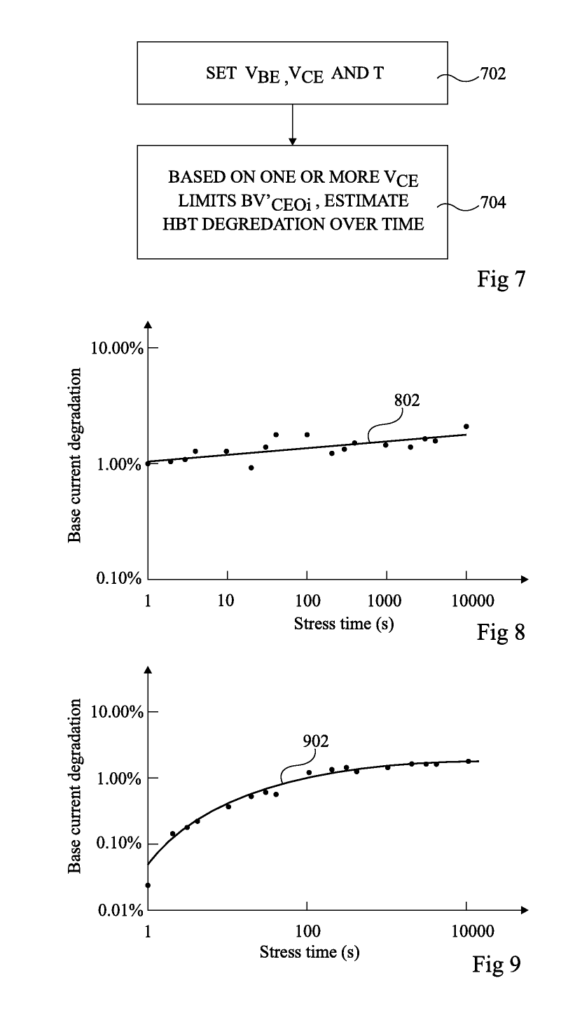

FIG. 7 illustrates a method of estimating the degradation of an HBT device according to an example embodiment.

In a step 702, parameters V_{BE}, V_{CE} and T are for example defined for a specific HBT device.

In a subsequent step 704, based on the one or more collector-emitter voltage limits BV′_{CEOi}, the HBT degradation is estimated for a given age, for example based on one or more Gummel plot characteristics.

For example, the step 702 involves determining, by simulation, a first collector-emitter voltage of the transistor for the base-emitter voltage V_{BE}. The step 704 for example involves determining an estimation of the base current degradation of the HBT device after a time duration (t) during which the first collector-emitter voltage is applied to the HBT device based on a comparison between the first collector-emitter voltage and the collector-emitter voltage limit. Indeed, the rate of degradation is for example a function of the extent to which the collector-emitter voltage exceeds the collector-emitter voltage limit.

In the case that the base emitter voltage V_{BE} is less than the voltage threshold V_{S}, avalanche degradation is assumed. The degradation with time may then be calculated based on the following equation:

degradation=At^{P1}

where A and P1 are constants. These constants can for example be determined, for a given collector emitter voltage V_{CE}, by device testing. In particular, the base-emitter and collector-emitter voltages are for example applied to an HBT device, and the base current degradation is measured at a number of time intervals. The values of A and p are then determined that will lead to a best fitting curve with respect to the measured base current degradation values. By calculating the constants A and P1 for at least two collector-emitter voltages, one of which is for example at the collector-emitter voltage limit, an interpolation between the degradations values provided by the equations can be used to calculate the degradation for various collector-emitter voltages.

FIG. 8 is a log-log graph illustrating base current degradation against time based on avalanche degradation, according to an example in which the collector emitter voltage V_{CE} is equal to the limit BV′_{CEOi} for example calculated by the method of FIG. 5. The plotted points in FIG. 8 represent base current degradation measurements, and the line 802 represents a best-fitting curve. In this example, the constant A is calculated as 0.0107 and the constant p as 0.0578. The degradation for a given age t in seconds can thus be determined by the equation: degradation(t)=0.0107t^{0.0578}.

In the case that the base emitter voltage V_{BE} is greater than the voltage threshold V_{S}, self-heating degradation is assumed. The degradation with time may then be calculated based on the following equation:

$$degradation = \frac{B}{\frac{1}{{t}^{P 2}} + C}$$

where B, C and P2 are constants, and t is the time in seconds that the stress is maintained. These constants can for example be determined for a given collector emitter voltage V_{CE} by testing. In particular, the collector-emitter voltage is applied to an HBT device, and the base current degradation is measured at a number of time intervals in order to determine the values of B, C and P2 that will lead to a best fit with respect to the measured current degradation. By calculating the constants B, C and P2 for at least two collector-emitter voltages, one of which is for example the collector-emitter voltage limit, an interpolation between the degradations values provided by the equations can be used to calculate the degradation for various collector-emitter voltages.

FIG. 9 is a log-log graph illustrating base current degradation against time based on self-heating degradation, according to an example in which the collector emitter voltage V_{CE} is equal to the limit BV′_{CEOi} for example calculated by the method of FIG. 4. The plotted points in FIG. 9 represent base current degradation measurements, and the line 902 represents a best-fitting curve.

An advantage of the embodiments described herein is that they lead to a significant improvement in the simulation of an HBT device. In particular, by determining a collector-emitter voltage limit based on a current density, a simulation method can be achieved that is applicable to a wide range of HBT devices, and that accurately determines the safe limits of operation. Furthermore, by defining the voltage limit in terms of a plurality of values respectively corresponding to different points on a base-emitter voltage waveform, the simulation can more accurately identify whether or not the voltage limit will be exceeded at any time during the operation of the HBT device.

Having thus described at least one illustrative embodiment, various alterations, modifications and improvements will readily occur to those skilled in the art.

For example, while methods based on avalanche degeneration and self-heating degeneration have been described, it will be apparent to those skilled in the art that alternative embodiments could be based on only one of these phenomena, and/or based on other types of degradation.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of circuit simulation comprising:
simulating, by a processing device, behavior of a heterojunction bipolar transistor (HBT) based on at least a first base-emitter voltage of said HBT to determine a first current density of a base or collector of said HBT; and
determining whether applying said first base-emitter voltage to said HBT would result in base current degradation by performing a first comparison of said first current density with a first current density limit.

2. The method of claim 1, wherein said first current density limit corresponds to an operating limit of said HBT, and determining whether said first base-emitter voltage would result in base current degradation comprises determining whether said operating limit is exceeded.

3. The method of claim 1, wherein said first current density is determined based on a first collector-emitter voltage of said HBT, the method further comprising:
simulating said HBT based on said first base-emitter voltage of said transistor and a second collector-emitter voltage to determine a second current density of the base or collector of said HBT;
performing a second comparison of said second current density with a second current density limit; and
determining a first collector-emitter voltage limit for said first base-emitter voltage based on said first and second comparisons.

4. The method of claim 3 further comprising:
determining, by said processing device for a second base-emitter voltage of said HBT, a second collector-emitter voltage limit;
determining, by simulation, the first collector-emitter voltage of said HBT for said first base-emitter voltage;
determining, by simulation, the second collector-emitter voltage of said HBT for said second base-emitter voltage; and
generating by said processing device an alert signal if said first collector-emitter voltage exceeds said first collector-emitter voltage limit or if said second collector-emitter voltage exceeds said second collector-emitter voltage limit.

5. The method of claim 1, further comprising:
determining, by simulation, a first collector-emitter voltage of said HBT for said first base-emitter voltage; and
determining an estimation of the base current degradation of said HBT after a time duration during which said first collector-emitter voltage is applied to said HBT based on a comparison between said first collector-emitter voltage and said first collector-emitter voltage limit.

6. The method of claim 5, wherein said estimation of the base current degradation of said HBT after a time duration is determined based on at least one of the equations:
deg radation=At^{P1}
where t is the time duration and A and P1 are constants; and
$$degradation = \frac{B}{\frac{1}{{t}^{P 2}} + C}$$
where t is the time duration and B, C and P2 are constants.

7. The method of claim 1, wherein the base-emitter voltage of said HBT has a periodic waveform having periods that are each defined by a plurality of base-emitter voltage values, the method further comprising:
determining a plurality of collector-emitter voltage limits, each limit corresponding to a respective one of said plurality of base-emitter voltage values;
determining by simulation a plurality of collector-emitter voltages each corresponding to a respective one of said plurality of base-emitter voltage values; and
generating by said processing device an alert signal if any one of said plurality of collector-emitter voltages exceeds a corresponding one of said plurality of collector-emitter voltage limits.

8. The method of claim 1, further comprising comparing said first base-emitter voltage with a voltage threshold, wherein:
if said first base-emitter voltage is lower than said voltage threshold, said first current density is a first base current density; and
if said first base-emitter voltage is higher than said voltage threshold, said first current density is a first collector current density.

9. The method of claim 1, wherein said first current density is a first base current density, the method further comprising, before performing said first comparison, determining said first current density limit by determining an initial base current density for said first base-emitter voltage, said first current density limit being equal to said initial base current density minus a maximum base current drop.

10. The method of claim 9, wherein said initial base current density is determined for a collector-emitter voltage in a range 0.2 to 1.5 V.

11. The method of claim 1, wherein said first current density is a first collector current density, the method further comprising, before performing said first comparison, determining said first current density limit based on said first base-emitter voltage and a corresponding temperature of said HBT.

12. The method of claim 11, wherein said first current density limit is determined by the following formula:
J_{CLi}=min[γe^{αT}^{ₑ}^{(βT+ζ)V}^{_{BE}},J_{Cmax}]
where γ, α, β and ζ are constants, T is the temperature of the HBT, V_{BE} is the first base-emitter voltage and J_{Cmax} is a maximum current limit independent of temperature or of the base-emitter voltage.

13. A non-transitory computer readable medium storing instructions that, when executed by a processing device, implement a method of circuit simulation comprising:
simulating, by a processing device, behavior of a heterojunction bipolar transistor (HBT) based on at least a first base-emitter voltage of said HBT to determine a first current density of a base or collector of said HBT; and
determining whether applying said first base-emitter voltage to said HBT would result in base current degradation by performing a first comparison of said first current density with a first current density limit.

14. The non-transitory computer readable medium of claim 13, wherein said first current density is determined based on a first collector-emitter voltage of said HBT, the method further comprising:
simulating said HBT based on said first base-emitter voltage of said transistor and a second collector-emitter voltage to determine a second current density of the base or collector of said HBT;
performing a second comparison of said second current density with a second current density limit; and
determining a first collector-emitter voltage limit for said first base-emitter voltage based on said first and second comparisons.

15. The non-transitory computer readable medium of claim 14, wherein the method further comprises:
determining, by said processing device for a second base-emitter voltage of said HBT, a second collector-emitter voltage limit;
determining, by simulation, the first collector-emitter voltage of said HBT for said first base-emitter voltage;
determining, by simulation, the second collector-emitter voltage of said HBT for said second base-emitter voltage; and
generating by said processing device an alert signal if said first collector-emitter voltage exceeds said first collector-emitter voltage limit or if said second collector-emitter voltage exceeds said second collector-emitter voltage limit.

16. The non-transitory computer readable medium of claim 13, wherein the method further comprises:
determining, by simulation, a first collector-emitter voltage of said HBT for said first base-emitter voltage; and
determining an estimation of the base current degradation of said HBT after a time duration during which said first collector-emitter voltage is applied to said HBT based on a comparison between said first collector-emitter voltage and said first collector-emitter voltage limit.

17. A circuit simulation device comprising:
a processing device configured to:
simulate behavior of a heterojunction bipolar transistor (HBT) based on at least a first base-emitter voltage of said HBT to determine a first current density of a base or collector of said HBT; and
determine whether applying said first base-emitter voltage to said HBT would result in base current degradation by performing a first comparison of said first current density with a first current density limit.

18. The circuit simulation device of claim 17, wherein the base-emitter voltage of said HBT has a periodic waveform having periods that are each defined by a plurality of base-emitter voltage values, the processing device being configured to:
determine a plurality of collector-emitter voltage limits, each limit corresponding to a respective one of said plurality of base-emitter voltage values;
determine by simulation a plurality of collector-emitter voltages each corresponding to a respective one of said plurality of base-emitter voltage values; and
generate by said processing device an alert signal if any one of said plurality of collector-emitter voltages exceeds a corresponding one of said plurality of collector-emitter voltage limits.

19. The circuit simulation device of claim 17, wherein the processing device is configured to compare said first base-emitter voltage with a voltage threshold, wherein:
if said first base-emitter voltage is lower than said voltage threshold, said first current density is a first base current density; and
if said first base-emitter voltage is higher than said voltage threshold, said first current density is a first collector current density.

20. The circuit simulation device of claim 17, wherein said first current density is a first base current density, the processing device being configured to, before performing said first comparison, determine said first current density limit by determining an initial base current density for said first base-emitter voltage, said first current density limit being equal to said initial base current density minus a maximum base current drop.
